(19) United States
(12) Patent Application Publication
(10) Pub. No.: US 2017/0095794 A1
(43) Pub. Date: Apr. 6, 2017

(54) NO Oxidation Activity of Pseudo-brookite Compositions as Zero-PGM Catalysts for Diesel Oxidation Applications

(71) Applicant: Clean Diesel Technologies, Inc., Oxnard, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Oxnard, CA (US)

(21) Appl. No.: 14/873,045

(22) Filed: Oct. 1, 2015

(51) Int. Cl. B01J 23/34; B01J 23/889; B01J 23/00

(52) U.S. Cl. CPC B01J 23/34; B01J 23/002; B01J 23/8892; B01J 2523/00

(57) ABSTRACT

Zero-PGM (ZPGM) catalyst materials including pseudo-brookite compositions for use in diesel oxidation catalyst (DOC) applications are disclosed. The disclosed doped pseudo-brookite compositions include A-site partially doped pseudo-brookite compositions, such as, Sr-doped and Ce-doped pseudo-brookite compositions, as well as B-site partially doped pseudo-brookite compositions, such as, Fe-doped, Co-doped, Ni-doped, and Ti-doped pseudo-brookite compositions. The disclosed doped pseudo-brookite compositions, including calcination at various temperatures, are subjected to a DOC standard light-off (LO) test methodology to assess/verify catalyst activity as well as to determine the effect of the use of a dopant in an A-site cation or a B-site cation within a pseudo-brookite composition. The disclosed doped pseudo-brookite compositions exhibit higher NO oxidation catalyst activities when compared to bulk powder pseudo-brookite, thereby indicating improved thermal stability and catalyst activity when using a dopant in an A-site cation or in a B-site cation within a pseudo-brookite composition.

### BACKGROUND

Field of the Disclosure

This disclosure relates generally to catalyst materials for diesel oxidation catalyst (DOC) systems, and more particularly, to pseudo-brookite catalyst materials having improved light-off (LO) performance and catalytic activity.

Background Information

Diesel engines offer superior fuel efficiency. However, one of the technical obstacles to the broad implementation of diesel engines is the requirement for an additional lean nitrogen oxide (NO_{X}) exhaust component within the overall diesel exhaust system. Conventional lean NO_{X} exhaust components are expensive to manufacture and are key contributors to the premium pricing associated with diesel engine equipped vehicles. Unlike a conventional gasoline engine exhaust, in which equal amounts of oxidants (O₂ and NO_{X}) and reductants (CO, H₂, and hydrocarbons) are available, diesel engine exhaust contains excessive O₂ due to combustion occurring at much higher air-to-fuel ratios (>20). This oxygen-rich environment makes the removal of NO_{X} much more difficult.

Conventional diesel exhaust systems employ diesel oxidation catalyst (DOC) technology and are referred to as diesel oxidation catalyst (DOC) systems. Typically, DOC systems include a substrate structure upon which promoting oxides are deposited. Bimetallic catalysts, based on platinum group metals (PGM), are then deposited upon the promoting oxides.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost DOC system exhibiting catalytic properties substantially similar to or better than the catalytic properties exhibited by DOC systems employing PGM catalyst materials.

### SUMMARY

The present disclosure describes Zero-PGM (ZPGM) catalyst materials for use in diesel oxidation catalyst (DOC) applications which include pseudo-brookite oxides expressed with a general formula of AB₂O₅, where both A and B sites are implemented as cations and the A and B sites can be interchangeable. Example materials that are suitable to form pseudo-brookite catalysts include, but are not limited to, silver (Ag), manganese (Mn), yttrium (Y), lanthanum (La), cerium (Ce), iron (Fe), praseodymium (Pr), neodymium (Nd), strontium (Sr), cadmium (Cd), cobalt (Co), scandium (Sc), copper (Cu), niobium (Nb), and tungsten (W). In some embodiments, the ZPGM pseudo-brookite catalyst materials, such as, YMn₂O₅ pseudo-brookite bulk powders, are produced by employing conventional synthesis methodologies.

In other embodiments, the A-site and/or B-site cations can be partially doped with base metals. In these embodiments, either A-site and/or B-site cations within the AB₂O₅ pseudo-brookite catalysts can be partially doped with a base metal including, but are not limited to, Sr, Ce, Fe, Co, Ni, and Ti, among others.

In an example, the A-site cation is substituted with Sr or Ce yielding pseudo-brookite compositions expressed with a general formula of (Y₁₋ₓAₓ)Mn₂O₅, where x=0.01 to 0.5. In another example, the B-site cation is substituted with Fe, Co, Ni, or Ti yielding pseudo-brookite compositions expressed with general formula of Y(Mn₂₋ₓBₓ)O₅, where x=0.01 to 0.5.

In some embodiments, X-ray diffraction (XRD) analyses are used to analyze/measure the pseudo-brookite phase formation and the thermal stability of the different doped pseudo-brookite compositions. In these embodiments, the XRD data is then analyzed to determine if the structure of the various doped pseudo-brookite compositions remain stable. If the structure of any of the doped pseudo-brookite compositions becomes unstable, new phases will form within the ZPGM catalyst material. Further to these embodiments, different calcination temperatures will result in different doped pseudo-brookite phases.

In some embodiments, the XRD analyses indicate the disclosed doped pseudo-brookite catalysts are stable when calcined within a temperature range from about 800° C. to about 1000° C. using nitrate combustion methodology.

In some embodiments, the disclosed doped pseudo-brookite compositions are subjected to a DOC standard light-off (LO) test methodology to assess/verify catalyst activity. In these embodiments, DOC LO tests are performed by employing a flow reactor, at a space velocity (SV) of about 54,000 h⁻¹. Further to these embodiments, the disclosed doped pseudo-brookite compositions exhibit higher NO oxidation catalyst activities when compared to bulk powder pseudo-brookite, thereby indicating improved thermal stability when using a dopant in an A-site cation or in a B-site cation within a pseudo-brookite catalyst.

In some embodiments, the disclosed doped pseudo-brookite compositions including a dopant in an A-site cation exhibit higher NO oxidation activity when compared to the disclosed doped pseudo-brookite compositions including a dopant in a B-site cation. In these embodiments, the disclosed doped pseudo-brookite catalysts can provide significantly improved ZPGM catalyst materials within DOC applications.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating an X-ray diffraction (XRD) phase stability analysis of an exemplary B-site partially doped pseudo-brookite catalyst implemented as Co-doped pseudo-brookite compositions and calcined at about 800° C., according to an embodiment.

FIG. 2 is a graphical representation illustrating an XRD phase stability analysis of an exemplary A-site partially doped pseudo-brookite catalyst implemented as Ce-doped pseudo-brookite compositions and calcined at about 800° C., according to an embodiment.

FIG. 3 is a graphical representation illustrating an XRD phase stability analysis of an exemplary A-site partially doped pseudo-brookite catalyst implemented as Ce-doped pseudo-brookite compositions and calcined at about 1000° C., according to an embodiment.

FIG. 4 is a graphical representation illustrating comparison DOC light off (LO) test results of NO conversion associated with bulk powder YMn₂O₅ pseudo-brookite, a Sr-doped pseudo-brookite composition, and a Ce-doped pseudo-brookite composition that are each calcined at about 800° C., according to an embodiment.

FIG. 5 is a graphical representation illustrating comparison of DOC LO test results of NO conversion associated with bulk powder YMn₂O₅ pseudo-brookite, a Sr-doped pseudo-brookite composition, and a Ce-doped pseudo-brookite composition that are each calcined at about 1000° C., according to an embodiment.

FIG. 6 is a graphical representation illustrating comparison DOC LO test results of NO conversion associated with bulk powder YMn₂O₅ pseudo-brookite, a Ti-doped pseudo-brookite composition, a Ni-doped pseudo-brookite composition, an Fe-doped pseudo-brookite composition, and a Co-doped pseudo-brookite composition that are each calcined at about 800° C., according to an embodiment.

FIG. 7 is a graphical representation illustrating comparison of DOC LO test results of NO conversion associated with bulk powder YMn₂O₅ pseudo-brookite, a Ti-doped pseudo-brookite composition, a Ni-doped pseudo-brookite composition, an Fe-doped pseudo-brookite composition, and a Co-doped pseudo-brookite composition that are each calcined at about 1000° C., according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms have the following definitions:

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Conversion” refers to the chemical alteration of at least one material into one or more other materials.

“Diesel oxidation catalyst (DOC)” refers to a device that utilizes a chemical process in order to break down pollutants within the exhaust stream of a diesel engine, turning them into less harmful components.

“Pseudobrookite” refers to a ZPGM catalyst, having AB₂O₅ structure of material which may be formed by partially substituting element “A” and “B” base metals with suitable non-platinum group metals.

“T₅₀” refers to the temperature at which 50% of a material is converted.

“X-ray diffraction (XRD) analysis” refers to a rapid analytical technique for verifying crystalline material structures, including atomic arrangement, crystalline size, and imperfections in order to identify unknown crystalline materials (e.g., minerals, inorganic compounds).

“Zero platinum group metal (ZPGM) catalyst” refers to a catalyst completely or substantially free of platinum group metals.

### DESCRIPTION OF THE DRAWINGS

The present disclosure describes Zero-PGM (ZPGM) catalyst materials with pseudo-brookite catalysts for use in diesel oxidation catalyst (DOC) applications. In some embodiments, pseudo-brookite catalysts are partially doped with suitable base metals in order to improve NO oxidation as well as to reduce DOC light off (LO) temperatures. In these embodiments, pseudo-brookite compositions include yttrium (Y) expressed with a general formula of YₓMn₂O₅.

In other embodiments, the pseudo-brookite catalysts are expressed with a general formula of AB₂O₅, where both A and B sites are implemented as cations and the A and B sites can be interchangeable.

In these embodiments, A-site or B-site cations within the pseudo-brookite catalysts are substituted with a base metal including, but are not limited to, Sr, Ce, Fe, Co, Ni, and Ti, among others. Further to these embodiments, the A-site cation is substituted with Sr or Ce yielding pseudo-brookite compositions expressed with a general formula of (Y₁₋ₓAₓ)Mn₂O₅, where x=0.01 to 0.5. Example formulas of the doped pseudo-brookite compositions are described in Table 1.

TABLE 1
Doped pseudo-brookite compositions (A-site substitution).

| DOPANT | FORMULATION |
|---|---|
| Sr | (Y_{0.9}Sr_{0.1})Mn₂O₅ |
| Ce | (Y_{0.9}Ce_{0.1})Mn₂O₅ |

In further embodiments, the B-site cation is substituted with Fe, Co, Ni, or Ti yielding pseudo-brookite compositions expressed with general formula of Y(Mn₂₋ₓBₓ)O₅ where x=0.01 to 0.5. Example formulas of the doped-pseudo-brookite compositions are described in Table 2.

TABLE 2
Doped pseudo-brookite compositions (B-site substitution).

| DOPANT | FORMULATION |
|---|---|
| Fe | Y(Mn_{1.9}Fe_{0.1})O₅ |
| Co | Y(Mn_{1.9}Co_{0.1})O₅ |
| Ni | Y(Mn_{1.9}Ni_{0.1})O₅ |
| Ti | Y(Mn_{1.9}Ti_{0.1})O₅ |

Disclosed doped pseudo-brookite compositions are employed in the production of catalyst coatings for ZPGM catalyst systems.

ZPGM Pseudo-Brookite Material Composition and Preparation

In some embodiments, the disclosed ZPGM pseudo-brookite compositions are produced using a nitrate combustion methodology. In these embodiments, the preparation begins by mixing the appropriate amount of Y nitrate solution, Mn nitrate solution and water to produce a Y—Mn solution at an appropriate molar ratio (Y:Mn) of about 1:2 for an YMn₂O₅ pseudo-brookite catalyst. Further to these embodiments, the Y—Mn solution is then fired from about 300° C. to about 400° C. for nitrate combustion. In these embodiments, the firing produces a Y—Mn solid material. Further to these embodiments, the Y—Mn solid material is ground and then calcined at a range of temperatures from about 800° C. to about 1000° C., for about 5 hours. In these embodiments, the grinding and calcination produces a Y—Mn powder. The calcined Y—Mn powder is then re-ground to fine grain powder yielding an YMn₂O₅ pseudo-brookite catalyst.

In an example, the A-site doped pseudo-brookite compositions include a formula of Y_{0.9}A_{0.1}Mn₂O₅, where A=Ce or Sr. In this example, a nitrate combustion methodology as described above is employed. In some embodiments, the nitrate combustion methodology begins when the appropriate amount of Y nitrate solution, Ce nitrate (or Sr nitrate), and Mn nitrate solution are mixed with water to produce a Y-A-Mn solution at an appropriate molar ratio (Y:A:Mn) of about 0.9:0.1:2. In these embodiments, the Y—Mn solution is then fired from about 300° C. to about 400° C. for nitrate combustion. Further to these embodiments, the firing produces a Y—Mn solid material. In these embodiments, the Y—Mn solid material is ground and calcined at a range of temperatures from about 800° C. to about 1000° C., for about 5 hours. Further to these embodiments, the grinding and calcination produces a Y—Mn powder. The calcined Y—Mn powder is then re-ground to fine grain powder of doped pseudo-brookite compositions having a formula of Y_{0.9}Ce_{0.1}Mn₂O₅ or Y_{0.9}Sr_{0.1}Mn₂O₅.

In another example, the B-site doped pseudo-brookite compositions include formula of YMn_{1.9}B_{0.1}O₅, where B=Fe, Co Ni, or Ti. In this example, a nitrate combustion methodology as described above is employed. In some embodiments, the nitrate combustion methodology begins when the appropriate amount of nitrate solution of Y, Mn, and a doped element, such as Fe, Co Ni, or Ti are mixed in order to produce a Y—Mn—B solution at an appropriate molar ratio (Y:Mn:B) of about 1:1.9:0.1. In these embodiments, the Y—Mn solution is then fired from about 300° C. to about 400° C. for nitrate combustion. Further to these embodiments, the Y—Mn material is ground and calcined at a range of temperatures from about 800° C. to about 1000° C., for about 5 hours. In these embodiments, the grinding and calcination produces a Y—Mn powder. The calcined Y—Mn powder is then re-ground to fine grain powder of doped pseudo-brookite composition having a formula of YMn_{1.9}Fe_{0.1}O₅, YMn_{1.9}Co_{0.1}O₅, YMn_{1.9}Ni_{0.1}O₅, or YMn_{1.9}Ti_{0.1}O₅.

In order to determine the phase formation and thermal stability of the disclosed doped pseudo-brookite compositions, X-ray diffraction (XRD) analyses are performed.

X-Ray Diffraction Analysis

In some embodiments, X-ray diffraction (XRD) analyses are used to analyze/measure the pseudo-brookite phase formation and the thermal stability of the different doped pseudo-brookite compositions. In these embodiments, the XRD data is then analyzed to determine if the structure of the various doped YMn₂O₅ pseudo-brookite remains stable. If the structure of any of the doped YMn₂O₅ pseudo-brookite compositions becomes unstable, new phases will form within the ZPGM catalyst material. Further to these embodiments, different calcination temperatures will result in different doped YMn₂O₅ pseudo-brookite phases.

In some embodiments, XRD patterns are measured on a powder diffractometer using Cu Ka radiation in the 2-theta range of about 15°-100° with a step size of about 0.02° and a dwell time of about 1 second. In these embodiments, the tube voltage and current are set to about 40 kV and about 30 mA, respectively. The resulting diffraction patterns are analyzed using the International Center for Diffraction Data (ICDD) database to identify phase formation. Examples of powder diffractometer include the MiniFlex™ powder diffractometer available from Rigaku® of Woodlands, Tex., USA.

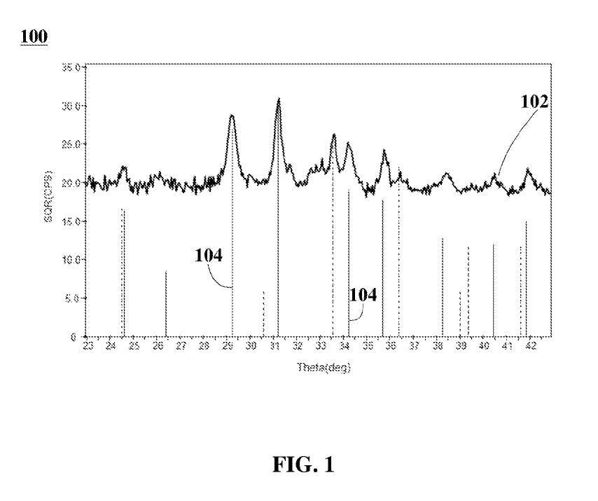

FIG. 1 is a graphical representation illustrating an X-ray diffraction (XRD) phase stability analysis of an exemplary B-site partially doped pseudo-brookite catalyst implemented as Co-doped pseudo-brookite compositions and calcined at about 800° C., according to an embodiment.

In FIG. 1, XRD analysis 100 includes XRD spectrum 102 and phase lines 104. In some embodiments, XRD spectrum 102 illustrates Co-doped pseudo-brookite composition (YMn_{1.9}Co_{0.1}O₅) spectrum, and phase lines 104 illustrate YMn₂O₅ pseudo-brookite phases. In these embodiments, after calcination the YMn₂O₅ pseudo-brookite phases are produced and arranged in an orthorhombic structure, as illustrated by phase lines 104. Therefore, the Co-doped pseudo-brookite compositions are stable.

In other embodiments, XRD analyses (not shown in FIG. 1) are performed on Co-doped pseudo-brookite compositions and calcined at about 1000° C. In these embodiments, the XRD analyses indicate the presence of pseudo-brookite phases, thereby confirming thermal stability of the pseudo-brookite composition. Further to these embodiments, when using nitrate combustion methodology at a calcination temperature of about 1000° C., both YMn₂O₅ brookite phase and CoMnO₃ perovskite phase are produced within the Co-doped pseudo-brookite compositions.

In some embodiments, XRD analyses (not shown in FIG. 1) are performed on Ni-doped and Fe-doped pseudo-brookite compositions, both calcined at about 800° C. and at about 1000° C. In these embodiments, the XRD analyses indicate Ni-doped and Fe-doped pseudo-brookite compositions exhibit similar results as the Co-doped pseudo-brookite compositions described above.

In other embodiments, XRD analyses (not shown in FIG. 1) are performed on Ti-doped pseudo-brookite compositions and calcined at about 800° C. In these embodiments, XRD analyses indicate there is no presence of crystalline pseudo-brookite phases; only amorphous material is present. Further to these embodiments, after calcination at about 1000° C., only pseudo-brookite phases are produced.

In some embodiments, XRD analyses (not shown in FIG. 1) are performed on the disclosed doped pseudo-brookite compositions and calcined at about 600° C. XRD analyses indicate no crystallite pseudo-brookite phase is produced at this temperature and that amorphous material is produced.

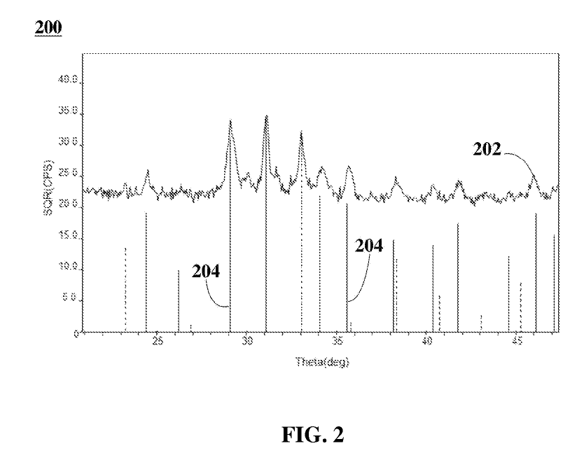

FIG. 2 is a graphical representation illustrating an XRD phase stability analysis of an exemplary A-site partially doped pseudo-brookite catalyst implemented as Ce-doped pseudo-brookite compositions and calcined at about 800° C., according to an embodiment.

In FIG. 2 XRD analysis 200 includes XRD spectrum 202 and phase lines 204. In some embodiments, XRD spectrum 202 illustrates Ce-doped pseudo-brookite compositions (Y_{0.9}Ce_{0.1}Mn₂O₅) spectrum, and phase lines 204 illustrate pseudo-brookite phases. In these embodiments, after calcination the YMn₂O₅ pseudo-brookite phases within the Ce-doped pseudo-brookite compositions are produced, as illustrated by phase lines 204.

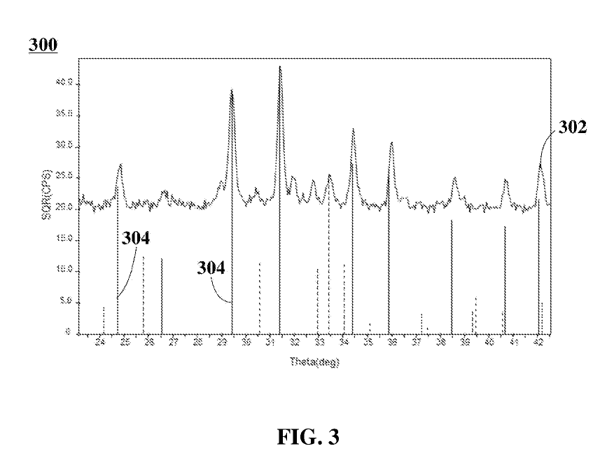

FIG. 3 is a graphical representation illustrating an XRD phase stability analysis of an exemplary A-site partially doped pseudo-brookite catalyst implemented as Ce-doped pseudo-brookite compositions and calcined at about 1000° C., according to an embodiment.

In FIG. 3, XRD analysis 300 includes XRD spectrum 302 and phase lines 304. In some embodiments, XRD spectrum 302 illustrates Ce-doped pseudo-brookite compositions (Y_{0.9}Ce_{0.1}Mn₂O₅) spectrum, and phase lines 304 illustrate pseudo-brookite phases. In these embodiments, after calcination the YMn₂O₅ pseudo-brookite phases within the Ce-doped pseudo-brookite compositions are produced, as illustrated by phase lines 304.

In other embodiments, XRD analyses (not shown in FIG. 3) are performed on Sr-doped pseudo-brookite compositions (Y_{0.9}Sr_{0.1}Mn₂O₅). In these embodiments, the XRD analyses indicate the YMn₂O₅ pseudo-brookite phases form more readily when using nitrate combustion methodology at about 800° C., or at about 1000° C. Further to these embodiments, the Sr-doped pseudo-brookite compositions are stable when using nitrate combustion methodology at a calcination temperature of about 1000° C.

In some embodiments, the disclosed doped pseudo-brookite compositions are subjected to a DOC standard light-off (LO) test methodology to assess/verify catalyst activity.

DOC Standard Light-Off Test

In some embodiments, the DOC standard light-off (LO) test methodology is applied to bulk powder YMn₂O₅ pseudo-brookite, A-site doped pseudo-brookite compositions, and B-site doped pseudo-brookite compositions. In these embodiments, the LO test is performed employing a flow reactor in which temperature is increased from about 75° C. to about 400° C. at a rate of about 40° C./min to measure the CO, HC and NO conversions. Further to these embodiments, a gas feed employed for the test includes a composition of about 100 ppm of NO_{X}, 1,500 ppm of CO, about 4% of CO₂, about 4% of H₂O, about 14% of O₂, and about 430 ppm of C₃H₆, and a space velocity (SV) of about 54,000 h⁻¹ or about 100,000 h⁻¹. In these embodiments, during DOC LO test, neither N₂O nor NH₃ are formed.

In some embodiments, DOC LO tests are performed in order to determine the effect of the use of a dopant in an A-site within a pseudo-brookite catalyst.

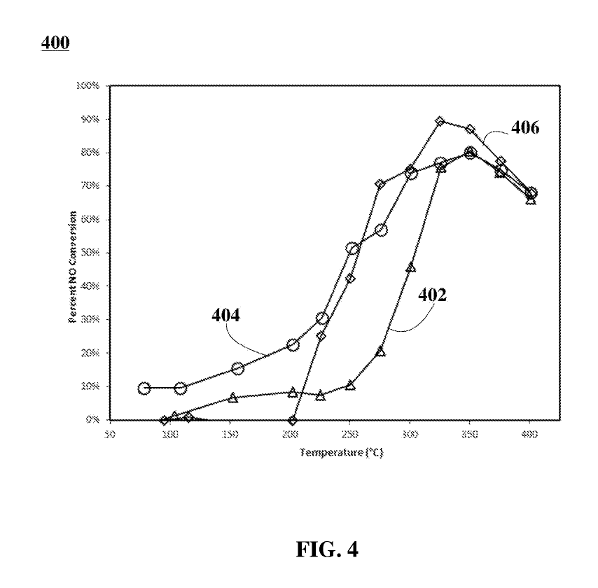

FIG. 4 is a graphical representation illustrating comparison DOC light off (LO) test results of NO conversion associated with bulk powder YMn₂O₅ pseudo-brookite, a Sr-doped pseudo-brookite composition, and a Ce-doped pseudo-brookite composition that are each calcined at about 800° C., according to an embodiment.

In FIG. 4, DOC LO test 400 includes conversion curve 402 (solid line with triangles), conversion curve 404 (solid line with circles), and conversion curve 406 (solid line with squares). In some embodiments, conversion curve 402 illustrates NO conversion of bulk powder YMn₂O₅ pseudo-brookite, conversion curve 404 illustrates NO conversion of Sr-doped pseudo-brookite compositions (Y_{0.9}Sr_{0.1}Mn₂O₅), and conversion curve 406 illustrates NO conversion of Ce-doped pseudo-brookite compositions (Y_{0.9}Ce_{0.1}Mn₂O₅). In these embodiments, bulk powder YMn₂O₅ pseudo-brookite exhibits high oxidation catalyst activity, which oxidizes NO up to 80% at a temperature of about 350° C. Further to these embodiments, for NO oxidation both the Sr-doped pseudo-brookite compositions and the Ce-doped pseudo-brookite compositions exhibits lower oxidation catalyst activity at lower temperature, as observed in the T50 values. In some embodiments, the bulk powder YMn₂O₅ pseudo-brookite exhibits a T50 of 305° C., the T50 value for Sr-doped pseudo-brookite compositions occurs at about 250° C.; and the T50 value for Ce-doped pseudo-brookite compositions occurs at about 257° C. In these embodiments, Ce-doped pseudo-brookite compositions exhibit higher maximum NO conversion of about 93% at a temperature of about 325° C. Further to these embodiments, Ce-doped pseudo-brookite compositions exhibit higher NO oxidation activity when compared to the bulk powder pseudo-brookite.

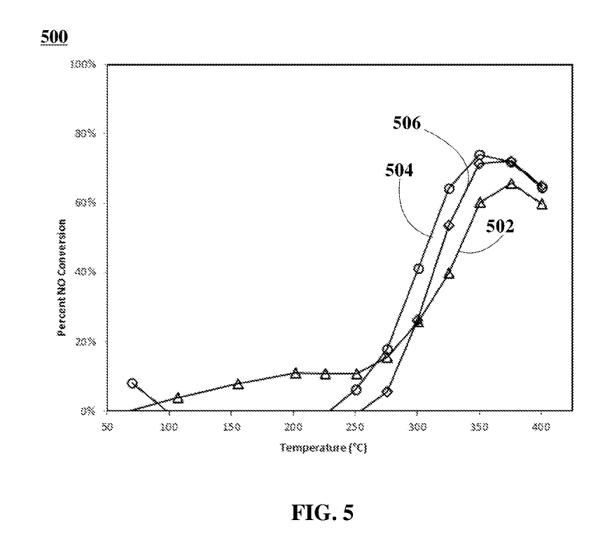

FIG. 5 is a graphical representation illustrating comparison of DOC LO test results of NO conversion associated with bulk powder YMn₂O₅ pseudo-brookite, a Sr-doped pseudo-brookite composition, and a Ce-doped pseudo-brookite composition that are each calcined at about 1000° C., according to an embodiment.

In FIG. 5, DOC LO test 500 includes conversion curve 502 (solid line with triangles), conversion curve 504 (solid line with circles), and conversion curve 506 (solid line with squares). In some embodiments, conversion curve 502 illustrates NO conversion of bulk powder YMn₂O₅ pseudo-brookite, conversion curve 504 illustrates NO conversion of Sr-doped pseudo-brookite compositions (Y_{0.9}Sr_{0.1}Mn₂O₅), and conversion curve 506 illustrates NO conversion of Ce-doped pseudo-brookite compositions (Y_{0.9}Ce_{0.1}Mn₂O₅). In these embodiments, the bulk powder YMn₂O₅ pseudo-brookite exhibits NO oxidation catalyst activity, which oxidizes NO up to 65% at a temperature of about 375° C. Further to these embodiments, for NO oxidation both the Sr-doped pseudo-brookite compositions and the Ce-doped pseudo-brookite compositions exhibit higher oxidation catalyst activity. In these embodiments, Sr-doped pseudo-brookite compositions oxidize NO at up to 72% at a temperature of about 350° C., and Ce-doped pseudo-brookite compositions oxidize NO at up to 74% at a temperature of about 350° C. In some embodiments, the disclosed doped pseudo-brookite compositions exhibit higher NO oxidation catalyst activities when compared to bulk powder YMn₂O₅ pseudo-brookite, thereby indicating improved thermal stability and catalyst activity when using a dopant in an A-site within a pseudo-brookite catalyst.

In other embodiments, DOC LO tests are performed in order to determine the effect of the use of a dopant in a B-site within a pseudo-brookite catalyst.

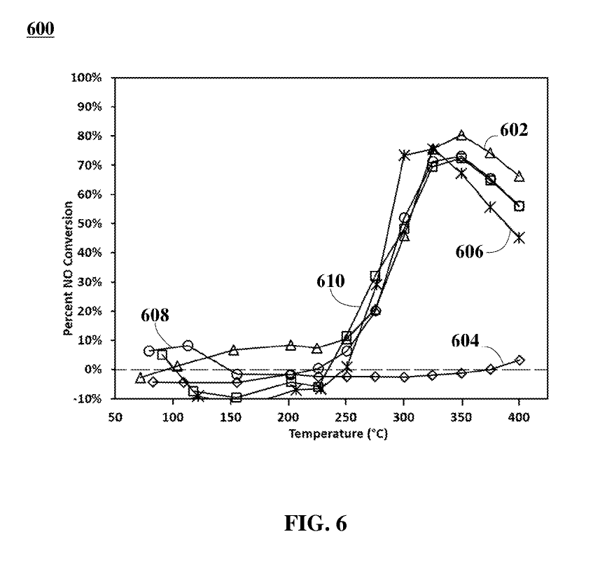

FIG. 6 is a graphical representation illustrating comparison DOC LO test results of NO conversion associated with bulk powder YMn₂O₅ pseudo-brookite, a Ti-doped pseudo-brookite composition, a Ni-doped pseudo-brookite composition, an Fe-doped pseudo-brookite composition, and a Co-doped pseudo-brookite composition that are each calcined at about 800° C., according to an embodiment.

In FIG. 6, DOC LO test 600 includes conversion curve 602 (solid line with triangles), conversion curve 604 (solid line with diamonds), conversion curve 606 (solid line with crosses), conversion curve 608 (solid line with circles), and conversion curve 610 (solid line with squares). In some embodiments, conversion curve 602 illustrates NO conversion of bulk powder YMn₂O₅ pseudo-brookite, conversion curve 604 illustrates NO conversion of Ti-doped pseudo-brookite compositions (YMn_{1.9}Ti_{0.1}O₅), conversion curve 606 illustrates NO conversion of Ni-doped pseudo-brookite compositions (YMn_{1.9}Ni_{0.1}O₅), conversion curve 608 illustrates NO conversion of Fe-doped pseudo-brookite compositions (YMn_{1.9}Fe_{0.1}O₅), and conversion curve 610 illustrates NO conversion of Co-doped pseudo-brookite compositions (YMn_{1.9}Co_{0.1}O₅).

In these embodiments, the bulk powder YMn₂O₅ pseudo-brookite exhibits high NO oxidation catalyst activity, which oxidizes NO up to 80% at a temperature of about 350° C. Further to these embodiments, Ni-doped pseudo-brookite compositions, Fe-doped pseudo-brookite compositions, and Co-doped pseudo-brookite compositions exhibit high NO oxidation catalyst activities. Ni-doped pseudo-brookite compositions oxidize NO at up to 73% at a temperature of about 350° C., Fe-doped pseudo-brookite compositions oxidize NO at up to 72% at a temperature of about 350° C., and Co-doped pseudo-brookite compositions oxidize NO at up to 75% at a temperature of about 350° C. In these embodiments, Ti-doped pseudo-brookite compositions do not exhibit NO oxidation activity. The absence of NO oxidation activity indicates the Ti dopant affects the activity of pseudo-brookite catalysts. This lack of activity is due to the absence of a pseudo-brookite phase at a calcination temperature of about 800° C.

In some embodiments, bulk powder YMn₂O₅ pseudo-brookite exhibits higher NO oxidation catalyst activities when compared to the disclosed doped pseudo-brookite compositions. In these embodiments, B-site doped pseudo-brookites do not increase NO oxidation of pseudo-brookite compositions. Further to these embodiments, Ni-doped pseudo-brookite exhibits slight improvement in LO temperature within the temperature range from about 265° C. to about 325° C. which allows improved NO conversion when compared to bulk powder pseudo-brookites.

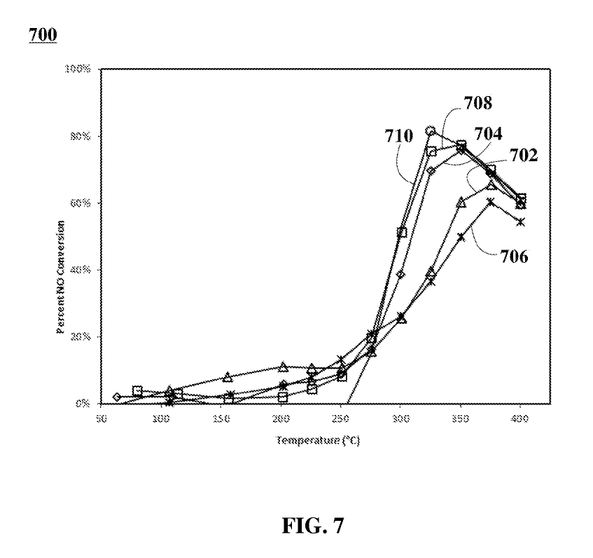

FIG. 7 is a graphical representation illustrating comparison of DOC LO test results of NO conversion associated with bulk powder YMn₂O₅ pseudo-brookite, a Ti-doped pseudo-brookite composition, a Ni-doped pseudo-brookite composition, an Fe-doped pseudo-brookite composition, and a Co-doped pseudo-brookite composition that are each calcined at about 1000° C., according to an embodiment.

In FIG. 7, DOC LO test 700 includes conversion curve 702 (solid line with triangles), conversion curve 704 (solid line with diamonds), conversion curve 706 (solid line with crosses), conversion curve 708 (solid line with squares), and conversion curve 710 (solid line with circles). In some embodiments, conversion curve 702 illustrates NO conversion of bulk powder YMn₂O₅ pseudo-brookite, conversion curve 704 illustrates NO conversion of Ti-doped pseudo-brookite compositions (YMn_{1.9}Ti_{0.1}O₅), conversion curve 706 illustrates NO conversion of Ni-doped pseudo-brookite compositions (YMn_{1.9}Ni_{0.1}O₅), conversion curve 708 illustrates NO conversion of Fe-doped pseudo-brookite compositions (YMn_{1.9}Fe_{0.1}O₅), and conversion curve 710 illustrates NO conversion of Co-doped pseudo-brookite compositions (YMn_{1.9}Co_{0.1}O₅). In these embodiments, the bulk powder YMn₂O₅ pseudo-brookite exhibits high NO oxidation catalyst activity, which oxidizes NO up to 65% at a temperature of about 375° C. Further to these embodiments, for NO oxidation the Ti-doped pseudo-brookite compositions, the Fe-doped pseudo-brookite compositions, and the Co-doped pseudo-brookite compositions all exhibit higher oxidation catalyst activities. In these embodiments, Ti-doped pseudo-brookite compositions oxidize NO at up to 76% at a temperature of about 350° C., Fe-doped pseudo-brookite compositions oxidize NO at up to 77% at a temperature of about 350° C., and Co-doped pseudo-brookite compositions oxidize NO at up to 82% at a temperature of about 325° C., respectively. In some embodiments, the disclosed doped pseudo-brookite compositions exhibit higher NO oxidation catalyst activities when compared to bulk powder YMn₂O₅ pseudo-brookite, thereby indicating improved thermal stability and catalyst activity when using a dopant in a B-site within a pseudo-brookite catalyst.

In some embodiments, DOC LO tests 400, 500, 600, and 700 indicate both the A-site partially substituted doped pseudo-brookite catalysts and the B-site partially substituted pseudo-brookite catalysts exhibit improvement of NO conversions and NO oxidation at lower LO temperatures. Such improvement is especially confirmed in A-site doped pseudo-brookite compositions.

In some embodiments, when calcination occurred at about 800° C. A-site substituted doped pseudo-brookite catalysts, such as Ce-doped pseudo-brookite compositions and Sr-doped pseudo-brookite compositions, exhibited higher NO conversion catalytic activities as compared to B-site substituted doped pseudo-brookite catalysts. In other embodiments, when calcination occurred at about 1000° C., both the A-site doped pseudo-brookite catalysts and the B-site doped pseudo-brookite catalysts exhibited higher NO conversion catalyst activities as compared to bulk powder YMn₂O₅ pseudo-brookites. Therefore, the disclosed doped pseudo-brookite catalysts can provide significantly improved ZPGM catalyst materials within DOC applications.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst composition comprising a pseudo-brookite structured compound of general formula Y₁₋ₓAₓMn_{2-y}B_{y}O₅, wherein the pseudo-brookite structured compound includes yttrium and manganese, wherein at least one selected from the group consisting of x and y is greater than 0, and wherein A and B are cations selected from the group consisting of cerium (Ce), strontium (Sr), iron (Fe), cobalt (Co), nickel (Ni), and titanium (Ti).

2. The catalyst composition of claim 1, wherein A is a cation selected from the group consisting of Ce and Sr, and wherein x is about 0.01 to about 0.5.

3. The catalyst composition of claim 2, wherein x is about 0.1.

4. The catalyst composition of claim 2, wherein A is Ce.

5. The catalyst composition of claim 2, wherein A is Sr.

6. The catalyst composition of claim 2, wherein the catalyst composition is calcined at a temperature from about 800° C. to about 1000° C.

7. The catalyst composition of claim 1, wherein B is a cation selected from the group consisting of Fe, Co, Ni, and Ti, and wherein y is about 0.1 to about 0.5.

8. The catalyst composition of claim 7, wherein y is about 0.1.

9. The catalyst composition of claim 7, wherein B is a cation selected from the group consisting of Fe, Co, and Ti, and wherein the catalyst composition is calcined at a temperature of about 1000° C.

10. The catalyst composition of claim 7, wherein B is Fe.

11. The catalyst composition of claim 7, wherein B is Co.

12. The catalyst composition of claim 7, wherein B is Ti.

13. The catalyst composition of claim 7, wherein B is Ni.

14. The catalyst composition of claim 13, wherein the catalyst composition is calcined at a temperature of about 800° C.

15. The catalyst composition of claim 7, wherein the catalyst composition is calcined at a temperature from about 800° C. to about 1000° C.

16. The catalyst composition of claim 1, wherein the catalyst composition is calcined at a temperature from about 800° C. to about 1000° C.

17. The catalyst composition of claim 1, wherein A is a cation selected from the group consisting of Ce and Sr, wherein B is a cation selected from the group consisting of Fe, Co, Ni, and Ti, wherein x is greater than 0, and wherein y is greater than 0.

18. The catalyst composition of claim 17, wherein x is about 0.01 to about 0.5.

19. The catalyst composition of claim 17, wherein y is about 0.01 to about 0.5.

20. The catalyst composition of claim 18, wherein y is about 0.01 to about 0.5.
